(19) United States
(12) Patent Application Publication
(10) Pub. No.: US 2024/0337728 A1
(43) Pub. Date: Oct. 10, 2024

(54) CLUSTERING SCAN POINTS OF A LASER SCANNER

(71) Applicant: VALEO SCHALTER UND SENSOREN GMBH, Bietigheim-Bissingen (DE)

(72) Inventors: Charles Thin, Bietigheim-Bissingen (DE); Jean Francois Bariant, Bietigheim-Bissingen (DE)

(73) Assignee: VALEO SCHALTER UND SENSOREN GMBH, Bietigheim-Bissingen (DE)

(21) Appl. No.: 18/292,176

(22) PCT Filed: Jul. 19, 2022
(86) PCT No.: PCT/EP2022/070139

§ 371 Date: Jan. 25, 2024

(30) Foreign Application Priority Data
Jul. 26, 2021 (DE) 10 2021 119 224.2

(51) Int. Cl. G01S 7/48; G01S 17/42; G01S 17/931

(52) U.S. Cl. CPC G01S 7/4802; G01S 17/42; G01S 17/931

(57) ABSTRACT

A method for recognizing an object in a surround of a laser scanner by clustering scan points of the laser scanner is disclosed. The method includes using the laser scanner to create a multiplicity of successive scan points and using at least one computing unit to determine, in a manner dependent on the sequence, at least one cluster of scan points containing some of the multiplicity of successive scan points. Each scan point is characterized by an angle of incidence. A sequence of the multiplicity of successive scan points is defined by the angles of incidence.

The present invention relates to a method for detecting an object in a surround of a laser scanner by clustering scan points of the laser scanner. The invention also relates to a method for at least partially automated guidance of a motor vehicle comprising a laser scanner and at least one computing unit, to a corresponding sensor system for a motor vehicle, and to a computer program product.

Lidar sensor systems may be mounted on motor vehicles in order to realize various functions for automated or partially automated driving, or for driver assistance. These functions include distance measurements, distance control algorithms, lane-keeping assist systems, object tracking functions, functions for autonomous driving and the like.

Known designs of lidar sensor systems include so-called laser scanners, in which a laser beam is deflected by means of a deflection unit, with the result that different deflection angles of the laser beam can be realized. For example, the deflection unit may comprise a rotatably mounted mirror or a mirror element with a tiltable and/or pivotable surface. The mirror element can be designed, for example, as a microelectromechanical system, MEMS. The emitted laser beams can be partly reflected in the surround, and the reflected components can be incident on the laser scanner in turn, in particular on the deflection unit which can steer these reflected components to a detector unit of the laser scanner. Each optical detector of the detector unit then generates, for example, an associated detector signal on the basis of the components recorded by the respective optical detector. Consequently, the direction of incidence of the detected reflected components can be deduced on the basis of the spatial arrangement of the respective detector, together with the current position of the deflection unit, in particular the latter's rotational position or tilt and/or pivot position. A radial distance of the reflective object can be determined on the basis of a time-of-flight measurement. For the distance determination, use can alternatively or additionally be made of a method according to which a phase difference between emitted and detected light is evaluated.

Many of the aforementioned functions, which are performed on the basis of corresponding scan points of a laser scanner, require that corresponding objects in the surround of the laser scanner be detected from the scan points. To this end, it is possible to identify groups of scan points, so-called clusters, which are located close together and accordingly have a high probability of belonging to a single physical object. Various methods are known for clustering unordered point clouds, for example a k-nearest neighbor algorithm (k-nearest-neighbor method).

A disadvantage of such approaches lies in the fact that it is necessary to calculate a very large number of distances between different scan points in order to determine whether certain points in the point cloud belong to the same cluster. If n points intended to be clustered are assumed to be in the point cloud, then the overall number of distances is n*(n−1)/2, which is to say it is of the order of O(n²). In view of the limited computing and storage resources, especially in the context of embedded systems as used in the automotive sector, this leads to high demands.

It is an object of the present invention to reduce the necessary computational outlay and/or storage requirements for detecting an object by clustering scan points of a laser scanner.

This object is achieved by the respective subject matter of the independent claims. Advantageous refinements and preferred embodiments are the subject matter of the dependent claims.

The invention is based on the concept of exploiting a natural sequence of the scan points given by the measurement principle or the structural design of a laser scanner in order to perform a more efficient cluster analysis of the scan points. To this end, at least one cluster of scan points of the laser scanner is determined in a manner dependent on the sequence which is defined by the respective angle of incidence of the scan points.

According to an aspect of the invention, a method for detecting an object in a surround of a laser scanner by clustering scan points of the laser scanner is specified. To this end, the laser scanner is used to create a multiplicity of successive scan points, wherein each scan point of the multiplicity of scan points is characterized, more particularly uniquely characterized, by an angle of incidence. A sequence of the multiplicity of successive scan points is defined by the angles of incidence of the scan points of the multiplicity of successive scan points. At least one computing unit is used to determine, in a manner dependent on the sequence of the multiplicity of successive scan points, at least one cluster of scan points, wherein each cluster of the one or more clusters contains a corresponding part of the multiplicity of scan points. In particular, each cluster of the one or more clusters consists of a corresponding part of the multiplicity of scan points.

Both here and hereinbelow, a laser scanner can be understood to mean a lidar sensor system designed as a laser scanner. In particular, the laser scanner contains a transmitter unit having one or more laser sources, for example infrared laser diodes, and a detector unit having one or more optical detectors, for example photodiodes, in particular avalanche photodiodes (APDs), and a control and evaluation unit configured to control the transmitter unit and the detector unit and to evaluate detector signals created by means of the optical detectors. In this case, the at least one computing unit may for example contain the evaluation and control unit of the laser scanner.

The laser scanner also contains a deflection unit arranged and configured to deflect into the surround of the laser scanner the laser beams created by means of the transmitter unit and to realize different transmission angles, especially within a transmission plane, in the process. Then again, reflected components of the transmitted laser beams may be incident on the deflection unit and accordingly guided thereby to the detector unit, where said reflected components can be detected by the appropriate optical detector or detectors. For example, the deflection unit may comprise a mirror that is rotatably mounted about an axis of rotation, the axis of rotation being perpendicular to the transmission plane. If a reflected component of the light is detected by means of the detector unit, then the direction of incidence of the detected components is determinable from the current position of the deflection unit, in particular of the mirror, in combination with the geometric arrangement of the respective detecting detector. Moreover, the control and evaluation unit may for example carry out a time-of-flight measurement in order to determine a radial distance.

In general, the direction of incidence can be defined by two angles in a polar coordinate system. Usually, these angles are referred to as horizontal angle of incidence or azimuth angle and polar angle or vertical angle of incidence. The horizontal angle of incidence then corresponds to an angle in the transmission plane and the polar angle corresponds to an angle perpendicular to the transmission plane.

The different polar angles can also be referred to as attitudes. Each attitude corresponds to an optical detector, especially if the optical detectors of the detector unit are arranged linearly in a direction parallel to the plane of rotation of the deflection mirror. A rotation of the mirror of the deflection unit through 360° can also be referred to as scan frame. Thus, each scan frame generally creates a multiplicity of scan points for one or more attitudes, wherein each scan point at an attitude is uniquely characterized by the corresponding rotational position of the mirror of the deflection unit and accordingly by the horizontal angle of incidence. For this reason, the scan points at an attitude have a naturally given sequence which corresponds to the succession of horizontal angles of incidence.

If reference is made to an angle of incidence, especially an angle of incidence that defines a sequence, in the context of the invention and in particular in the method according to the invention, or here and hereinbelow, then this always relates to the horizontal angle of incidence. By contrast, if necessary, the polar angle is referred to explicitly as vertical angle of incidence, as attitude or attitude index, or the like.

Thus, the multiplicity of successive scan points which are created on the basis of the method according to the invention and whose sequence is defined by the angles of incidence can be understood to be a multiplicity of scan points at one attitude. However, there might also be pre-processing of the point cloud, with the result that a plurality of attitudes can be combined and processed together. In any case, the assumption can be made hereinbelow that the sequence is defined by the vertical angles of incidence but not by the attitude index.

Moreover, the assumption can be made that all scan points of the multiplicity of successive scan points have different angles of incidence, i.e. different horizontal angles of incidence. Attention is drawn to the fact that the rotatably mounted mirror of the deflection unit may optionally comprise a plurality of mirror surfaces, for instance two opposing mirror surfaces. The reflections from different mirror surfaces can be considered independently of one another. In other words, the assumption can be made below that the multiplicity of successive scan points are all the result of reflections from the same mirror surface.

Moreover, the multiplicity of successive scan points are not necessarily unfiltered raw data; instead, one or more pre-processing steps, for example for reducing noise or for other filtering purposes, may also be implemented upstream.

Accordingly, the sequence of the multiplicity of successive scan points can be understood to be a uniform increase or reduction, more particularly an incremental increase or reduction, of the angle of incidence or, in other words, of the associated rotational position of the rotatably mounted mirror.

By virtue of the multiplicity of successive scan points being characterized by their sequence, the multiplicity of successive scan points contain exactly one start point, which has exactly one subsequent point, and exactly one end point, which has exactly one preceding point. Moreover, the multiplicity of successive scan points contains one or more intermediate points, each of which has exactly one preceding point and one subsequent point.

A cluster can be understood to be a subset of the scan points. The number of scan points in a cluster can be greater than or equal to 1, with the maximum number in a cluster being given by the total number of the multiplicity of successive scan points.

To determine the at least one cluster, i.e. to identify which scan points of the multiplicity of successive scan points belong to the at least one cluster or to the same cluster, it is possible to take account of distances between different scan points. Here and hereinbelow, a distance can always be understood to be a geometric distance, in particular a Euclidean distance, between the scan points. However, according to the invention, the at least one cluster is not determined exclusively in a manner dependent on the distance between different scan points. Rather, the at least one cluster is determined in a manner dependent on the sequence, i.e. the sequence is taken into account when determining the at least one cluster. In particular, when making a decision as to whether or not a scan point belongs to a certain cluster, due consideration is given to where the scan point in question is located within the multiplicity of successive scan points. In other words, its position within the sequence or according to the sequence is taken into account. For example, this can be implemented by virtue of one or more distances of the scan point in question being analyzed not in relation to all other scan points of the multiplicity of successive scan points but only in a certain neighborhood within the sequence. For example, consideration may be given only to nearest neighbors or to nearest neighbors and next-but-one neighbors or to nearest neighbors, next-but-one neighbors and next-but-two neighbors, and so on.

Moreover, different threshold values for maximum distances may be considered in the process, depending on whether the corresponding scan points are at adjacent positions according to the sequence, i.e. are nearest neighbors, or whether they are next-but-one neighbors, next-but-two neighbors, etc. The direction of the sequence, i.e. which scan point according to the sequence immediately follows another scan point, or which immediately precedes the other one, is constant, i.e. defined, but in principle as desired.

Taking account of the sequence when determining the at least one cluster in particular ensures that it is ever more probable for two points of the multiplicity of successive points to belong to the same cluster, the closer their respective positions are according to the sequence. Attention is drawn to the fact that the geometric distances of the scan points nevertheless represent a relative criterion for the cluster analysis. Mere proximity of the positions of two scan points within the sequence on its own may in some cases not suffice to assign these scan points to the same cluster.

Thus, the method according to the invention efficiently exploits the information arising from the constructive design of the laser scanner, and thus defining the sequence, in order to reduce the required number of computational steps, in particular the number of distances between pairs of scan points which need to be calculated. The computational outlay and/or the required storage capacity can be reduced as a result.

Clustering the scan points, i.e. determining the at least one cluster, can be understood as detecting an object in the sense that scan points belonging to the same cluster have an increased probability of corresponding to a single physical object in the surround of the laser scanner, i.e. of being traced back to reflections from a corresponding surface of this object. In other words, detecting the object in this sense contains the determination of the presence or location of an object in the surround of the laser scanner with a certain probability. In particular, the detection of the object does not necessarily contain the classification of the object or the determination of a bounding box, and so on. However, the at least one cluster can be used for such purposes, for example by virtue of serving as a basis for an algorithm for automated perception.

In other words, the at least one cluster may serve as a basis or input for an algorithm for automated perception, for example an object tracking algorithm, a classification algorithm, a segmentation algorithm, etc.

According to at least one embodiment of the method, a first scan point of the multiplicity of scan points is identified as part of a first cluster of the one or more clusters, and a distance is determined between the first scan point and a second scan point of the multiplicity of scan points. The second scan point is identified as part of the first cluster if the distance is less than or equal to a given maximum distance.

For example, the first scan point can be determined as initial point of the first cluster, or likewise according to an embodiment of the method according to the invention.

In particular, the second scan point according to the sequence may immediately follow the first scan point. In this way, each pair of immediately successive scan points of the multiplicity of successive scan points can be considered, their Euclidean distance from one another can be determined, and the two points of the pair can be assigned to the same cluster if the distance is less than the given maximum distance for nearest neighbors. According to at least one embodiment, the given maximum distance depends on a position of the first scan point according to the sequence in relation to a position of the second scan point according to the sequence.

In other words, the maximum distance is determined in a manner dependent on the respective positions of the first and the second scan point according to the sequence. In particular, the position of the first scan point in relation to the position of the second scan point can thus be considered to be the difference in the positions.

In this way, it is possible for example to allow for a greater maximum distance between scan points that are closer together within the sequence than between scan points that are further apart within the sequence.

For example, a maximum distance may be given for nearest neighbors and a further maximum distance may be given for all pairs of scan points which are not nearest neighbors. Then, for example, the maximum distance for nearest neighbors may be greater than the maximum distance for all other pairs of scan points. What this achieves is that scan points which are nearest neighbors are assigned to the same cluster, and hence to the same object, with a higher probability than points which are spaced further apart from one another according to the sequence.

Further gradations can be implemented in analogous fashion, for example by virtue of being able to specify a maximum distance for next-but-one neighbors and optionally a maximum distance for next-but-two neighbors, and so on, in addition to a maximum distance for nearest neighbors.

According to at least one first embodiment of the method, a first scan point of the multiplicity of successive scan points is identified as part of a first cluster of the one or more clusters. A second scan point of the multiplicity of successive scan points which immediately follows the first scan point according to the sequence is identified as part of a second cluster of the one or more clusters. A distance is determined between the first scan point and a third scan point of the multiplicity of successive scan points which immediately follows the second scan point according to the sequence. The third scan point is identified either as part of the first cluster or as part of a third cluster of the one or more clusters depending on the distance between the first scan point and the third scan point.

To determine that the second scan point does not belong to the first cluster, it is for example possible to establish that the distance between the first scan point and the second scan point is greater than a given maximum distance for nearest neighbors. For example, it is also possible that the distance between the second scan point and the third scan point is likewise greater than the maximum distance for nearest neighbors, with the result that the third scan point does not belong to the second cluster.

However, since the sequence of the multiplicity of successive scan points is taken into account when determining the clusters, it is possible in particular to verify whether the first and the third scan point are close together despite both the first scan point and the third scan point each being far away from the second scan point which, according to the sequence, is located therebetween. What this can achieve is that the third scan point is not incorrectly assigned to a different cluster than the first scan point even though both may be traced back to reflections from the same object.

When reference is made here and hereinbelow to the fact that two scan points are close together or located far apart from one another, this can be understood to mean that, should nothing else be mentioned, the distance between the corresponding points is less than or equal to or, respectively, greater than a corresponding given maximum distance.

In particular, the third scan point is determined as part of the first cluster if the distance between the first scan point and the third scan point is less than or equal to a given maximum distance for next-but-one neighbors.

For example, the third scan point is determined as part of the third cluster if the distance between the first scan point and the third scan point is greater than the given maximum distance for next-but-one neighbors.

According to at least one second embodiment of the method, a first scan point of the multiplicity of successive scan points is identified as part of a first cluster of the one or more clusters. A distance is determined between a second scan point of the multiplicity of successive scan points which immediately follows the first scan point according to the sequence and a third scan point of the multiplicity of successive scan points which immediately follows the second scan point according to the sequence. A distance is determined between the first scan point and the third scan point. The second scan point is identified either as part of the first cluster or as part of a second cluster of the one or more clusters depending on the distance between the first scan point and the third scan point and depending on the distance between the second scan point and the third scan point.

In particular, the distance between the first scan point and the second scan point is greater than the given maximum distance for nearest neighbors in this case. Otherwise the second scan point would be part of the first cluster in any case, without the distance between the first scan point and the third scan point or the distance between the second scan point and the third scan point being decisive.

Thus, such embodiments can advantageously handle those situations in which the second scan point is far away from the first scan point but the third scan point is close to both the second scan point and the second scan point.

In particular, the second scan point is identified as part of the first cluster if the distance between the first scan point and the third scan point is less than or equal to a given maximum distance for next-but-one neighbors and the distance between the second scan point and the third scan point is less than or equal to a given maximum distance for nearest neighbors.

The maximum distances for nearest neighbors and next-but-one neighbors could be different in this case, but they could also be the same.

In particular, the second point is identified as part of the second cluster if the distance between the first scan point and the third scan point is greater than the given maximum distance for next-but-one neighbors of if the distance between the second scan point and the third scan point is greater than the given maximum distance for nearest neighbors.

According to at least one third embodiment of the method, a first scan point of the multiplicity of successive scan points is identified as part of a first cluster of the one or more clusters. A distance is determined between a second scan point of the multiplicity of successive scan points which immediately follows the first scan point according to the sequence and a third scan point of the multiplicity of successive scan points which immediately follows the second scan point according to the sequence. A distance is determined between the third scan point and a fourth scan point which immediately follows the third scan point according to the sequence. A distance is determined between the fourth scan point and the first scan point. The second scan point is identified either as part of the first cluster or as part of a second cluster of the one or more clusters depending on the distance between the second scan point and the third scan point and depending on the distance between the third scan point and the fourth scan point and depending on the distance between the fourth scan point and the first scan point.

Such embodiments can advantageously efficiently handle those situations in which the first and the second scan point and the first and the third scan point are located far apart from one another but both the second and the third scan point and also the third and the fourth scan point are in each case close together, just like the fourth and the first scan point.

In particular, the second scan point is identified as part of the first cluster if the distance between the second scan point and the third scan point is less than or equal to a given maximum distance for nearest neighbors and the distance between the third scan point and the fourth scan point is less than or equal to the given maximum distance for nearest neighbors and said distance between the fourth scan point and the first scan point is less than or equal to a given maximum distance for next-but-two neighbors.

In this case, too, the maximum distance for nearest neighbors can be the same as the maximum distance for next-but-two neighbors, or the maximum distances can be different.

In particular, the second scan point is identified as part of the second cluster if the distance between the second scan point and the third scan point is greater than the maximum distance for nearest neighbors or if the distance between the third scan point and the fourth scan point is greater than the maximum distance for nearest neighbors or if the distance between the fourth scan point and the first scan point is greater than the maximum distance for next-but-two neighbors.

According to at least one fourth embodiment of the method, a first scan point of the multiplicity of successive scan points is identified as part of a first cluster of the one or more clusters. A distance is determined between a second scan point of the multiplicity of successive scan points which immediately follows the first scan point according to the sequence and a fourth scan point of the multiplicity of successive scan points. In this case, a third scan point of the multiplicity of successive scan points immediately follows the second scan point according to the sequence, and the fourth scan point immediately follows the third scan point according to the sequence. A distance is determined between the fourth scan point and a fifth scan point of the multiplicity of successive scan points which immediately follows the fourth scan point according to the sequence. A distance is determined between the fifth scan point and the first scan point. The second scan point is identified either as part of the first cluster or as part of a second cluster of the one or more clusters depending on the distance between the second scan point and the fourth scan point and depending on the distance between the fourth scan point and the fifth scan point and depending on the distance between the fifth scan point and the first scan point.

Such embodiments can advantageously efficiently handle those situations in which the first scan point is far away from both the second and the fourth scan point, the second scan point and the fourth scan point are each far away from the third scan point, the second scan point is located close to the fourth scan point, the fourth scan point is located close to the fifth scan point, and the fifth scan point is located close to the first scan point.

For example, the second scan point can be identified as part of the first cluster if the distance between the second scan point and the fourth scan point is less than or equal to a given maximum distance for next-but-one neighbors and the distance between the fourth scan point and the fifth scan point is less than or equal to a given maximum distance for nearest neighbors and the distance between the fifth scan point and the first scan point is less than or equal to a given maximum distance for next-but-three neighbors.

By contrast, the second scan point can be identified as part of the second cluster if the distance between the second scan point and the fourth scan point is greater than the maximum distance for next-but-one neighbors or if the distance between the fourth scan point and the fifth scan point is greater than the maximum distance for nearest neighbors or if the distance between the fifth scan point and the first scan point is greater than the maximum distance for next-but-three neighbors.

The variants of the method denoted above as first, second, third or fourth embodiments can also be combined, with the result that the described situations can also be confronted together in appropriate configurations of the method.

According to at least one embodiment of the method, the at least one computing unit is used to perform an algorithm for automated perception on the basis of the multiplicity of successive scan points, wherein the algorithm is performed in a manner dependent on the at least one cluster.

A further aspect of the invention specifies a method for at least partially automated guidance of a motor vehicle, wherein the motor vehicle comprises a laser scanner and at least one computing unit. A method according to the invention for detecting an object is performed, in particular by means of the laser scanner and the at least one computing unit, wherein the method contains the performance of the algorithm for automated perception. At least one control signal for at least partially automated guidance of the motor vehicle is created depending on a result of the algorithm for automated perception, in particular by means of a control unit of the motor vehicle, for example a control unit comprised by the at least one computing unit.

Then, the motor vehicle can be subject to at least partially automated guidance depending on the at least one control signal. To this end, the at least one control signal can be supplied to, for example, one or more actuators of the motor vehicle or the one or more actuators can be controlled accordingly depending on the at least one control signal, in order to guide the motor vehicle in automated or partially automated fashion.

According to a further aspect of the invention, a sensor system for a motor vehicle is specified. The sensor system comprises a laser scanner configured to create sensor data which represent an object in a surround of the laser scanner, and hence in a surround of the motor vehicle in particular. The sensor system comprises at least one computing unit configured to create a multiplicity of successive scan points on the basis of the sensor data, wherein each scan point is characterized by an angle of incidence, and a sequence of the multiplicity of successive scan points is defined by the angles of incidence. The at least one computing unit is configured to determine, in a manner dependent on the sequence, at least one cluster of scan points containing some of the multiplicity of successive scan points.

Further embodiments of the sensor system according to the invention follow immediately from the various configurations of the method according to the invention for detecting an object and from the various configurations of the method according to the invention for at least partially automated guidance of a motor vehicle, and vice versa in each case. In particular, a sensor system according to the invention can be configured to perform a method according to the invention for detecting an object, or performs such a method.

According to a further aspect of the invention, an electronic vehicle guidance system for a motor vehicle is specified. The electronic vehicle guidance system contains a sensor system according to the invention for a motor vehicle. The at least one computing unit is configured to perform an algorithm for automated perception on the basis of the multiplicity of successive scan points and depending on the at least one cluster. A control unit of the electronic vehicle guidance system, in particular of the at least one computing unit, is configured to create at least one control signal for at least partially automated guidance of the motor vehicle depending on a result of the algorithm for automated perception.

Further embodiments of the electronic vehicle guidance system according to the invention follow immediately from the various configurations of the method according to the invention for detecting an object and from the method according to the invention for at least partially automated guidance of a motor vehicle. In particular, an electronic vehicle guidance system according to the invention can be configured to perform a method according to the invention for at least partially automated guidance of a motor vehicle, or performs such a method.

According to a further aspect of the invention, a first computer program product having first instructions is specified. When the first instructions are carried out by a sensor system according to the invention, the first instructions prompt the sensor system to perform a method according to the invention for detecting an object.

According to a further aspect of the invention, a second computer program having second instructions is specified. When the second instructions are carried out by an electronic vehicle guidance system according to the invention, the second instructions prompt the electronic vehicle guidance system to perform a method according to the invention for at least partially automated guidance of a motor vehicle.

According to a further aspect of the invention, a computer-readable storage medium is specified, the latter storing a first computer program according to the invention and/or a second computer program according to the invention.

The first computer program, the second computer program, and the computer-readable storage medium can each be regarded as respective computer program products having the first and/or the second instructions.

Within the scope of the present disclosure, the term “light” may be understood as comprising electromagnetic waves in the visible range, in the infrared range, and/or in the ultraviolet range. Accordingly, the term “optical” may also be understood as relating to light in this sense.

Algorithms for automated visual perception, which may also be referred to as computer vision algorithms, algorithms for machine vision or machine vision algorithms, may be considered to be computer algorithms for automated performance of a visual perception task. A visual perception task, which is also referred to as computer vision task, may for example be understood to mean a task regarding the extraction of information from image data. In particular, the visual perception task can in principle be carried out by a human who is able to visually perceive an image corresponding to the image data. However, visual perception tasks are also performed automatically in the present context without human assistance being necessary.

For example, a computer vision algorithm may contain an image processing algorithm or an algorithm for image analysis, which is or was trained by machine learning and which can be based for example on an artificial neural network, in particular a convolutional neural network. For example, the computer vision algorithm may comprise an object detection algorithm, an obstacle detection algorithm, an object tracking algorithm, a classification algorithm and/or a segmentation algorithm.

Corresponding algorithms may also be performed analogously on the basis of input data other than images visually perceivable by humans. For example, point clouds or images from infrared cameras, lidar systems, etc. may also be evaluated by means of appropriately adapted computer algorithms. Strictly speaking, the corresponding algorithms are not algorithms for visual perception since the corresponding sensors may operate in ranges that are not perceptible visually, i.e. to the human eye, for example in the infrared range. Therefore, such algorithms are referred to within the scope of the present invention as algorithms for automated perception. Thus, algorithms for automated perception include algorithms for automated visual perception, but are not restricted to the latter in view of human perception. Consequently, an algorithm for automated perception according to this understanding may contain a computer algorithm for automated performance of a perception task, which for example is or was trained by machine learning and which in particular may be based on an artificial neural network. Such generalized algorithms for automated perception may also include object detection algorithms, object tracking algorithms, classification algorithms and/or segmentation algorithms, for example semantic segmentation algorithms.

If an artificial neural network is used to implement an algorithm for automated visual perception, then a frequently employed architecture is that of a convolutional neural network, CNN. In particular, a 2-D CNN can be applied to corresponding 2-D camera images. CNNs may also be used for other algorithms for automated perception. For example, 3-D CNNs, 2-D CNNs or 1-D CNNs may be applied to point clouds, depending on the spatial dimensions of the point cloud and the processing details.

The result or the output of an algorithm for automated perception depends on the specific underlying perception task. For example, the output of an object detection algorithm may contain one or more bounding boxes which define a spatial position and optionally an orientation of one or more corresponding objects in the surround and/or appropriate object classes for the one or more objects. A semantic segmentation algorithm applied to a camera image may contain a class at the pixel level for each pixel of the camera image. In a manner analogous thereto, a semantic segmentation algorithm applied to a point cloud may contain a corresponding point level class for each of the points. The classes on the pixel level or point level may for example define an object type, to which the respective pixel or point belongs.

Here, an electronic vehicle guidance system can be understood as an electronic system which is configured to guide a vehicle fully automatically or fully autonomously, in particular without control intervention by a driver being necessary. The vehicle performs all necessary functions, for example steering, braking and/or acceleration maneuvers, the observation and detection of road traffic and appropriate reactions, automatically. In particular, the electronic vehicle guidance system may implement a fully automatic or fully autonomous driving mode of the motor vehicle according to Level 5 of the classification according to SAE J3016. An electronic vehicle guidance system may also be understood as an advanced driver assistance system (ADAS), which assists the driver during partially automated or partially autonomous driving. In particular, the electronic vehicle guidance system may implement a partially automated or partially autonomous driving mode according to Levels 1 to 4 according to the SAE J3016 classification. Here and hereinbelow, “SAE J3016” refers to the corresponding standard in the version of June 2018.

The at least partially automated vehicle guidance may therefore involve guiding the vehicle according to a fully automated or fully autonomous driving mode according to Level 5 according to SAE J3016. The at least partially automated vehicle guidance may also involve guiding the vehicle according to a partially automated or partially autonomous driving mode according to Levels 1 to 4 according to SAE J3016.

If reference is made within the scope of the present disclosure to a component of the sensor system according to the invention, in particular the at least one computing unit of the sensor system, being configured, embodied, designed, or the like to carry out or implement a specific function, to obtain a specific effect or to serve a specific purpose, then this can be understood to the effect that the component is specifically and actually able to carry out or implement the function, to obtain the effect or to serve the purpose, beyond the fundamental or theoretical usability or suitability of the component for this function, effect or purpose, by way of an appropriate adaptation, appropriate programming, an appropriate physical design and so on.

In particular, a computing unit can be understood to mean a data processing device, i.e. the computing unit can in particular process data for the purpose of performing computing operations. Optionally, these also include operations for performing indicated accesses to a data structure, for example a lookup table (LUT).

In particular, the computing unit may contain one or more computers, one or more microcontrollers and/or one or more integrated circuits, for example one or more application-specific integrated circuits (ASICs), one or more field-programmable gate arrays (FPGAs) and/or one or more systems on a chip (SoCs). The computing unit may also contain one or more processors, for example one or more microprocessors, one or more central processing units (CPUs), one or more graphics processing units (GPUs) and/or one or more signal processors, in particular one or more digital signal processors (DSPs). The computing unit may also contain a physical or virtual group of computers or other types of the aforementioned units.

The computing unit of various exemplary embodiments contains one or more hardware and/or software interfaces and/or one or more storage units.

A storage unit may be configured as volatile data memory, for example as dynamic random access memory (DRAM) or static random access memory (SRAM), or as non-volatile data memory, for example as a read-only memory (ROM), as programmable read-only memory (PROM), as erasable read-only memory (EPROM), as electrically erasable read-only memory (EEPROM), as flash memory or flash EEPROM, as ferroelectric random access memory (FRAM), as magnetoresistive random access memory (MRAM) or as phase-change random access memory (PCRAM).

Further features of the invention can be found in the claims, the figures, and the description of the figures. The features and combinations of features mentioned above in the description and the features and combinations of features mentioned below in the description of the figures and/or shown in the figures can be included in the invention not only in the combination specified in each case, but also in other combinations. In particular, embodiments and combinations of features that do not have all the features of an originally worded claim are also included in the invention. Furthermore, embodiments and combinations of features that go beyond or differ from the combinations of features set out in the back-references of the claims are included in the invention.

In the figures:

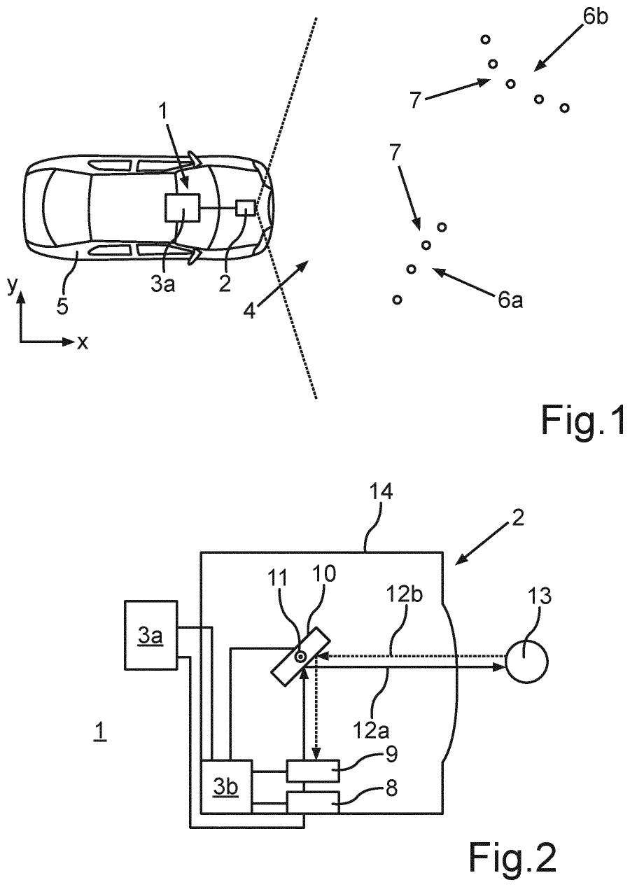

FIG. 1 shows a schematic illustration of a motor vehicle having an exemplary embodiment of a sensor system according to the invention;

FIG. 2 shows a schematic illustration of a further exemplary embodiment of a sensor system according to the invention for a motor vehicle;

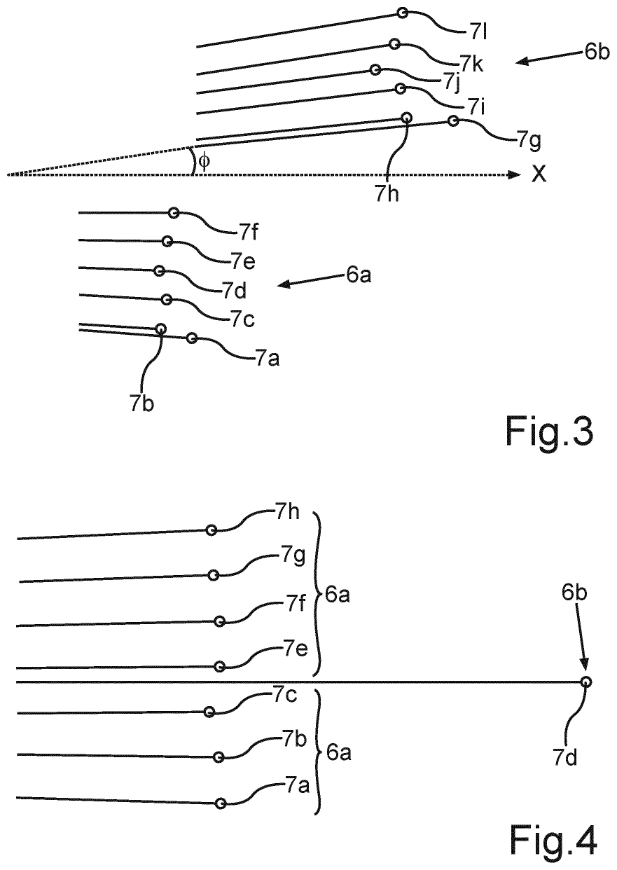

FIG. 3 shows a schematic illustration of a multiplicity of scan points;

FIG. 4 shows a further schematic illustration of a multiplicity of scan points;

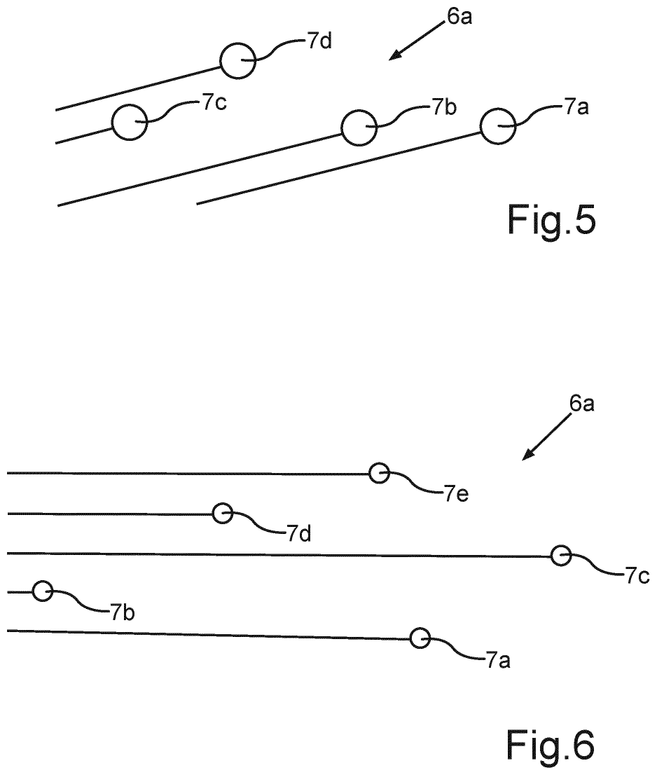

FIG. 5 shows a further schematic illustration of a multiplicity of scan points;

FIG. 6 shows a further schematic illustration of a multiplicity of scan points;

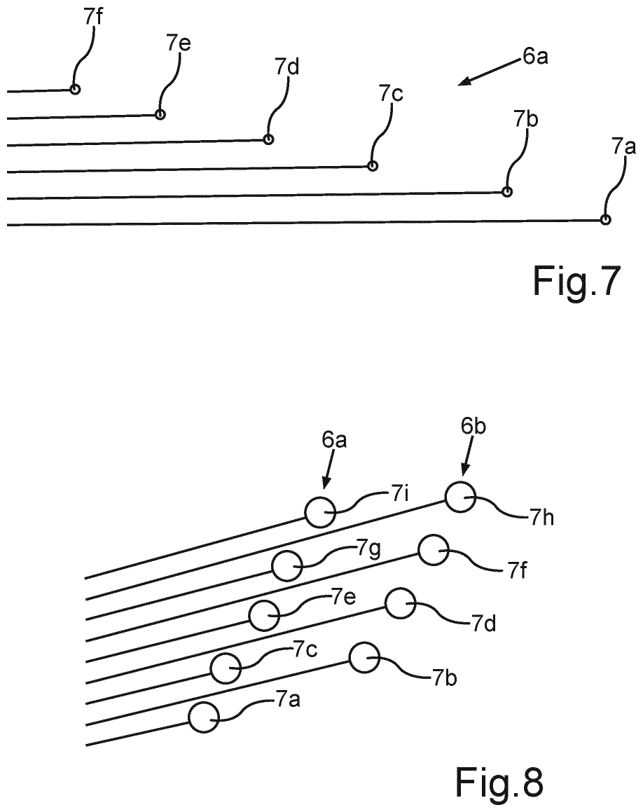

FIG. 7 shows a further schematic illustration of a multiplicity of scan points; and

FIG. 8 shows a further schematic illustration of a multiplicity of scan points.

FIG. 1 schematically depicts a motor vehicle 5 which comprises an exemplary embodiment of a sensor system 1 according to the invention. The sensor system 1 contains a lidar sensor system in the form of a laser scanner 2 and contains a computing unit 3a which may for example be configured as an electronic control unit, ECU, or a part thereof or which may contain an ECU.

The laser scanner 2 comprises a field of view 4 and can emit light in a transmission plane spanned by a longitudinal axis x and a transverse axis y. The laser scanner 2 is able to detect reflected components of the emitted light signals, and the laser scanner 2 and/or the computing unit 3a can create a multiplicity of scan points 7 on the basis of the detected components.

In FIG. 2, an exemplary embodiment of the sensor system 1 is depicted schematically.

The laser scanner 2 may comprise a control and evaluation unit 3b, which is connected to the computing unit 3a. In an alternative, the computing unit 3a may also adopt the function of the control and evaluation unit 3b, or vice versa. The laser scanner 2 comprises an emitter unit 8, which contains one or more laser diodes and which can be controlled by the control and evaluation unit 3b. The laser scanner 2 also comprises a detector unit 9, which comprises one or more optical detectors, for example avalanche photodiodes, and which is also connected to the control and evaluation unit 3b. The laser scanner 2 also comprises a mirror 10 that is rotatably mounted about an axis of rotation 11. In particular, the axis of rotation 11 is perpendicular to the transmission plane. The control and evaluation unit 3b is also able to control or determine the rotational position of the mirror 10.

During operation, the emitter unit 8, under the control of the control and evaluation unit 3b, emits laser pulses 12a which are deflected by the mirror 10, with the result that these pulses are able to leave a housing 14 of the laser scanner 2 into the surround of the laser scanner 2 and motor vehicle 5. If the laser pulses 12a are incident on an object 13 in the surround of the motor vehicle 5, then these laser pulses may be at least partially reflected by said object. The reflected components 12b may in turn be incident on the laser scanner 2 and, via the housing 14, on the mirror 10, which deflects said reflected components to the detector unit 9. One of the optical detectors in the detector unit 9 may detect the reflected components 12b, and the computing unit 3a or the control and evaluation unit 3b may create appropriate scan points 7 on the basis thereof. On account of the laser pulses 12a and the reflected components 12b propagating at the speed of light, the mirror position of the mirror 10 upon detection of the reflected components 12 essentially corresponds exactly to the mirror position when the laser pulses 12a were emitted. In combination with a time-of-flight measurement, the control and evaluation unit 3b is thus able to determine three-dimensional coordinates, for example in a polar coordinate system, for each scan point. Thus, each scan point is characterized in particular by the corresponding rotational position of the mirror 10 and the corresponding horizontal angle of incidence within the xy-plane or transmission plane, referred to as angle of incidence hereinbelow, a polar angle or attitude index and a radial distance. The attitude index corresponds to the optical detector by means of which the reflected components 12b of the corresponding scan point were detected. The optical detectors of the detector unit 9 are in particular arranged linearly and parallel to the axis of rotation 11, i.e. perpendicular to the transmission plane.

The mirror 10 may have a respective reflective mirror surface on a plurality of sides. These mirror surfaces may be treated as separate mirrors. A rotation of the mirror 10 through 360° about the axis of rotation 11 can be referred to as a scan frame, wherein each scan frame contains a scan frame for the first surface and a scan frame for the second surface in the case of two reflective surfaces. The explanations given below can be regarded as relating to the scan frame of a single mirror surface. The explanations apply analogously to further mirror surfaces. Thus, each scan frame creates a multiplicity of successive scan points 7 for each attitude, said scan points being able to be assigned to an angle of incidence in each case and therefore having a sequence defined by the angle of incidence. Only one attitude of scan points is considered below. Further attitudes can be treated accordingly.

For example, the emitter unit 8 can create the laser pulses 12a such that one laser pulse is emitted per rotation of the mirror through a constant angular increment. For example, the angular increment can be of the order of 0.1° to 1°, for example approximately 0.25°.

The computing unit 3a can cluster the scan points 7 in order to assign the scan points 7 to one or more objects 13 in the surround of the motor vehicle 5. According to the invention, the computing unit 3a takes account of the sequence of the scan points 7, as specified by the successive angles of incidence in the transmission plane, for clustering, i.e. for determining at least one cluster 6a, 6b.

The sensor system 1 is configured to perform a method according to the invention for detecting an object 13 in the surround of the laser scanner 2, in particular in the surround of the motor vehicle 5. The computing unit 3a determines the at least one cluster 6a, 6b in this way. Optionally, the computing unit 3a may perform an algorithm for automated perception, for example an object tracking algorithm or the like, on the basis of the clustered scan points 7. On the basis of a result of the algorithm for automated perception, the computing unit 3a or any other control unit (not depicted here) of the motor vehicle 5 is able to create at least one control signal for at least partially automated guidance of the motor vehicle. On the basis of the control signals, the motor vehicle 5 can then be guided in automated or partially automated fashion.

FIG. 3 to FIG. 7 in the drawings illustrate different situations, in which the scan points 7 are spaced apart from one another in different ways. Various embodiments of the method according to the invention will now be explained in more detail with reference to FIG. 3 to FIG. 7.

A multiplicity of scan points 7a to 7l are depicted in FIG. 3. In this case, each scan point is depicted as a circle with a straight line, the straight line indicating the direction from the scan point to the axis of rotation 11. Accordingly, the angle of incidence ϕ equals the angle that the corresponding line makes with the x-axis.

In order to cluster the scan points 7a to 7l, the computing unit 3a can verify which scan points 7a to 7l have a distance from other scan points 7a to 7l of less than a given cluster distance, which may also be referred to as maximum distance. If two scan points are referred to below as being far from one another, this may be understood to mean that the distance between the two scan points is greater than the cluster distance, and if the two scan points are referred to as being close together, this may be understood to mean that the distance between the two scan points is less than or equal to the cluster distance. Further, the assumption is made that only one cluster distance is defined. However, a plurality of cluster distances may also be specified in alternative embodiments in accordance with the sequence given by the angles of incidence, for example for nearest neighbors, next-but-one neighbors, and so on.

In order to cluster the scan points 7a to 7l, the computing unit 3a could in principle calculate all distances between all scan points 7a to 7l and compare these distances to the cluster distance. However, this would be accompanied by high demands on computational power and memory. Therefore, according to the invention, the natural sequence of the scan points 7a to 7l which arises from the above-described creation of the scan points is exploited.

For example, in the example of FIG. 3, a first scan point 7a may be followed by a second scan point 7b, which in turn is followed by the third scan point 7c, and so on. Now, the computing unit 3a may restrict itself to, for example, the distance between adjacent scan points according to the sequence. Accordingly, for n scan points, the number of distances to be calculated is reduced from O(n²) to O(n). In the present example, the computing unit 3a for example determines that the cluster condition is satisfied in each case for all successive scan points 7a to 7f, i.e. the scan points immediately following one another in each case are spaced apart from one another by less than the cluster distance. However, scan point 7f and scan point 7g, immediately following it, are far apart from one another, their distance from one another being greater than the cluster distance in particular. Accordingly, scan points 7a to 7f are determined as part of a first cluster 6a and the remaining scan points 7h to 7l are determined as part of a second cluster 6b, since the cluster condition is also satisfied in each case for respective adjacent pairs of the scan points 7h to 7l. The computational and memory outlay can be reduced in this example by taking account of the sequence.

A situation with eight scan points 7a to 7h is depicted in FIG. 4. If the sequence is followed from 7a to 7h, then the second scan point 7b is close to the first scan point 7a, the third scan point 7c is close to the second scan point 7b, the fourth scan point 7d is far away from the third scan point 7c, the fifth scan point 7e is far away from the fourth scan point 7d, and each of the remaining scan points 7f to 7h is also close to its preceding point. Moreover, however, the fifth scan point 7e is also close to the third scan point 7c, i.e. close to its next-but-one preceding point or next-but-one neighbor. In other words, if the fourth scan point 7d were to be ignored, then all remaining scan points 7a to 7c, 7e to 7h would belong to the same cluster 6a. The fourth scan point 7d would form the basis of a second cluster 6b. To obtain this plausible result, an additional verification step can be performed in a corresponding embodiment of the method should a scan point along the sequence be determined as being far away from its preceding scan point.

In the example of FIG. 4, the verification would thus be as follows: As initial point, the scan point 7a belongs to the first cluster 6a. The second scan point 7b is close to the first scan point 7a and therefore also belongs to the first cluster 6a. The third scan point 7c is close to the second scan point 7b and therefore also belongs to the first cluster 6a. The fourth scan point 7d is far away from the third scan point 7c and therefore potentially does not belong to the first cluster 6a but to a second cluster 6b. To verify this, the distance is determined between the fourth scan point 7d and its next-but-one preceding point, i.e. the second scan point 7b. This distance is also greater than the cluster distance, and so the fourth scan point 7d does in fact belong to a second cluster 6b in the present case. The fifth scan point 7e is far away from the second scan point 7b, and so it potentially does not belong to the second cluster 6b. For verification purposes, the distance to its next-but-one preceding point, the third scan point 7c, is determined. This distance is less than the cluster distance, and so the fifth scan point 7e also belongs to the first cluster 6a. This is continued in analogous fashion, with the result that the remaining scan points 7f to 7h are also assigned to the first cluster 6a.

FIG. 5 depicts a further situation, in which four successive scan points 7a, 7b, 7c, 7d are shown. The first scan point 7a establishes a first cluster 6a. The second scan point 7b, following it, is close to the first scan point 7a and therefore also belongs to the first cluster 6a. The third scan point 7c, following it, is far away from the second scan point 7b and could therefore belong to another cluster. In this embodiment, the verification on the basis of the next-but-one preceding point, i.e. the first scan point 7a, does not lead to a different result either since the distance between the scan points 7a and 7c is also greater than the cluster distance. However, the fourth scan point 7d following the third scan point 7c is less far away from both the third scan point 7c and its preceding point, the second scan point 7b, than the cluster distance. Thus, all four scan points 7a, 7b, 7c, 7d can be assigned to the first cluster 6a in this situation.

The concept of transitivity described with respect to FIG. 5 is extended by another level in FIG. 6. In this case, five successive scan points 7a, 7b, 7c, 7d, 7e are shown. The first scan point 7a establishes the first cluster 6a. The subsequent second scan point 7b is far away from the first scan point 7a. The third scan point 7c is also far away from the second scan point 7b, but close to the first scan point 7a. The fourth scan point 7d is also far away from its preceding point, the third scan point 7c, and also far away from the first scan point 7a. However, the third scan point 7c is close to the second scan point 7b. The fifth scan point 7e is close to its preceding point, the fourth scan point 7d, close to its next-but-one preceding point, the third scan point 7c, and also close to the first scan point 7a. Thus, all scan points 7a, 7b, 7c, 7d, 7e can be assigned to the same cluster 6a in this case.

Further levels of transitivity can be added in analogous fashion. In particular, this makes it possible to strike a balance between computational outlay and exactness of the clustering result.

Moreover, the cluster distance may for example be chosen to be greater for nearest neighbors of scan points than for other pairs of points. As schematically depicted in FIG. 7, if the angle between the emission direction of the laser pulses and the reflective surface is correspondingly flat then the distances between two successive scan points may be relatively large even though these points originate from the same object.

Geometric distances may be calculated as squared distances in a specific implementation. Accordingly, there would never be the need to calculate roots, and this likewise leads to computational time savings. Intermediate results relating to the distances have to be stored for various embodiments, for example as described in relation to FIG. 5 and FIG. 6.

FIG. 8 shows a further typical example. Nine scan points 7a to 7i are depicted here. Successive scan points in each pair are spaced apart from one another further than the cluster distance. By contrast, each pair of next-but-one neighbors, i.e. the pairs of scan points 7a and 7c, 7c and 7e, 7e and 7g, 7g and 7i and also the pairs of scan points 7b and 7d, 7d and 7f, 7f and 7h, are close together in each case. For example, this situation may arise if two relatively long objects are arranged in succession. What is achieved in the manner described above is that the associated scan points 7a, 7c, 7e, 7g, 7i are assigned to the first cluster 6a and the remaining scan points 7b, 7d, 7f, 7h are assigned to the second cluster 6b.

1. A method for recognizing an object in a surround of a laser scanner by clustering scan points of the laser scanner, the method comprising:
creating, using the laser scanner, a multiplicity of successive scan points,
wherein each scan point is characterized by an angle of incidence, and
wherein a sequence of the multiplicity of successive scan points is defined by the angles of incidence; and
determining, using at least one computing unit, in a manner dependent on the sequence, at least one cluster of scan points containing some of the multiplicity of successive scan points.

2. The method as claimed in claim 1, further comprising:
identifying a first scan point of the multiplicity of successive scan points as part of a first cluster of the one or more clusters;
determining a distance between the first scan point and a second scan point of the multiplicity of successive scan points;
identifying the second scan point as part of the first cluster if the distance is less than or equal to a given maximum distance.

3. The method as claimed in claim 2,
wherein the maximum distance depends on a position of the first scan point according to the sequence in relation to a position of the second scan point according to the sequence.

4. The method as claimed in claim 1, further comprising:
identifying a first scan point of the multiplicity of successive scan points as part of a first cluster of the one or more clusters;
identifying a second scan point of the multiplicity of successive scan points which immediately follows the first scan point according to the sequence as part of a second cluster of the one or more clusters;
determining a distance between the first scan point and a third scan point of the multiplicity of successive scan points which immediately follows the second scan point according to the sequence;
identifying the third scan point either as part of the first cluster or as part of a third cluster of the one or more clusters depending on the distance between the first scan point and the third scan point.

5. The method as claimed in claim 4,
wherein the third scan point is determined as part of the first cluster if the distance between the first scan point and the third scan point is less than or equal to a given maximum distance for next-but-one neighbors.

6. The method as claimed in claim 1, further comprising:
identifying a first scan point of the multiplicity of successive scan points as part of a first cluster of the one or more clusters;
determining a distance between a second scan point of the multiplicity of successive scan points which immediately follows the first scan point according to the sequence and a third scan point of the multiplicity of successive scan points which immediately follows the second scan point according to the sequence;
determining a distance between the first scan point and the third scan point;
identifying the second scan point either as part of the first cluster or as part of a second cluster of the one or more clusters depending on the distance between the first scan point and the third scan point and depending on the distance between the second scan point and the third scan point.

7. The method as claimed in claim 6,
wherein the second scan point is identified as part of the first cluster if the distance between the first scan point and the third scan point is less than or equal to a given maximum distance for next-but-one neighbors and the distance between the second scan point and the third scan point is less than or equal to a given maximum distance for nearest neighbors.

8. The method as claimed in claim 1, further comprising:
identifying a first scan point of the multiplicity of successive scan points as part of a first cluster of the one or more clusters;
determining a distance between a second scan point of the multiplicity of successive scan points which immediately follows the first scan point according to the sequence and a third scan point of the multiplicity of successive scan points which immediately follows the second scan point according to the sequence;
determining a distance between the third scan point and a fourth scan point of the multiplicity of successive scan points which immediately follows the third scan point according to the sequence;
determining a distance between the fourth scan point and the first scan point; and
identifying the second scan point either as part of the first cluster of the one or more clusters of the one or more clusters depending on the distance between the second scan point and the third scan point and depending on the distance between the third scan point and the fourth scan point and depending on the distance between the fourth scan point and the first scan point.

9. The method as claimed in claim 8,
wherein the second scan point is identified as part of the first cluster if the distance between the second scan point and the third scan point is less than or equal to a given maximum distance for nearest neighbors and the distance between the third scan point and the fourth scan point is less than or equal to the given maximum distance for nearest neighbors and the distance between the fourth scan point and the first scan point is less than or equal to a given maximum distance for next-but-two neighbors.

10. The method as claimed in claim 1, further comprising:
identifying a first scan point of the multiplicity of successive scan points as part of a first cluster of the one or more clusters;
determining a distance between a second scan point of the multiplicity of successive scan points which immediately follows the first scan point according to the sequence and a fourth scan point of the multiplicity of successive scan points,
wherein a third scan point of the multiplicity of successive scan points immediately follows the second scan point according to the sequence and the fourth scan point immediately follows the third scan point according to the sequence;
determining a distance between the fourth scan point and a fifth scan point of the multiplicity of successive scan points which immediately follows the fourth scan point according to the sequence;
determining a distance between the fifth scan point and the first scan point; and
identifying the second scan point either as part of the first cluster or as part of a second cluster of the one or more clusters depending on the distance between the second scan point and the fourth scan point and depending on the distance between the fourth scan point and the fifth scan point and depending on the distance between the fifth scan point and the first scan point.

11. The method as claimed in claim 10,
wherein the second scan point is identified as part of the first cluster if the distance between the second scan point and the fourth scan point is less than or equal to a given maximum distance for next-but-one neighbors and the distance between the fourth scan point and the fifth scan point is less than or equal to a given maximum distance for nearest neighbors and the distance between the fifth scan point and the first scan point is less than or equal to a given maximum distance for next-but-three neighbors.

12. The method as claimed in claim 1,
wherein the at least one computing unit is used to perform an algorithm for automated perception on the basis of the multiplicity of successive scan points,
wherein the algorithm for automated perception is performed in a manner dependent on the at least one cluster.

13. A method for at least partially automated guidance of a motor vehicle, the motor vehicle comprising:
a laser scanner and at least one computing unit,
the method comprising:
performing a method for detecting an object as claimed in claim 12; and
creating at least one control signal for at least partially automated guidance of the motor vehicle depending on a result of the algorithm for automated perception.

14. A sensor system for a motor vehicle,
the sensor system comprising:
a laser scanner configured to create sensor data that represent an object in a surround of the laser scanner; and
at least one computing unit configured to:
create a multiplicity of successive scan points on the basis of the sensor data,
wherein each scan point is characterized by an angle of incidence, and a sequence of the multiplicity of successive scan points is defined by the angles of incidence; and
to determine, in a manner dependent on the sequence, at least one cluster of scan points containing some of the multiplicity of successive scan points.

15. A non-transitory computer readable medium comprising for causing a system to perform a method as claimed in claim 1.
